(19) United States
(12) Patent Application Publication
(10) Pub. No.: US 2025/0372671 A1
(43) Pub. Date: Dec. 4, 2025

(54) FUEL CELL SYSTEM HAVING HYDROGEN SEPARATION AND HYDROGEN REGENERATION CAPABILITY

(71) Applicants: Hyundai Motor Company, Seoul (KR); Kia Corporation, Seoul (KR)

(72) Inventors: Jee Youn Hwang, Hwaseong (KR); So Hwa Kim, &Hwaseong (KR); Songi Oh, &Hwaseong (KR); Hyoun Myung Park, &Hwaseong (KR); Sung Hee Shin, &Hwaseong (KR); Ah Hyeon Park, &Hwaseong (KR); Won Jae Choi, &Hwaseong (KR); Da Hee Kwak, &Hwaseong (KR)

(21) Appl. No.: 18/954,094

(22) Filed: Nov. 20, 2024

(30) Foreign Application Priority Data
May 30, 2024 (KR) 10-2024-0070587

(51) Int. Cl. H01M 8/04089; H01M 4/92; H01M 8/0234; H01M 8/0239; H01M 8/0282; H01M 8/04082; H01M 8/0612; H01M 8/10; H01M 8/1004; H01M 8/103; H01M 8/1034

(52) U.S. Cl. CPC H01M 8/04089; H01M 4/92; H01M 8/0234; H01M 8/0239; H01M 8/0282; H01M 8/04201; H01M 8/0618; H01M 8/1004; H01M 8/103; H01M 8/1034; H01M 2008/1095; H01M 2300/0082

(57) ABSTRACT

Provided is a fuel cell system that includes an electrochemical hydrogen pump (EHP) and a polymer electrolyte membrane fuel cell (PEMFC). The EHP comprises a first membrane-electrode assembly with a first electrolyte membrane, anode, cathode, and bipolar plate, while the PEMFC includes a second membrane-electrode assembly with similar components. Hydrogen generated by the EHP is supplied to the PEMFC's anode for power generation. The system features high-temperature operation, efficient hydrogen transfer via a silica adhesive, and optimized bipolar plates made from graphitic carbon with low resistance and thermosetting resin content. The system ensures efficient power generation with minimal hydrogen loss and operates without the need for additional mechanical or electrical balance of plant components.

### CROSS-REFERENCE TO RELATED APPLICATION

This application claims, under 35 U.S.C. § 119(a), the benefit of Korean Patent Application No. 10-2024-0070587, filed on May 30, 2024, the entire contents of which are incorporated herein by reference.

### BACKGROUND

### (a) Technical Field

The present disclosure relates to a fuel cell system having hydrogen separation and hydrogen regeneration capabilities. This innovative system integrates an electrochemical hydrogen pump (EHP) with a polymer electrolyte membrane fuel cell (PEMFC) to efficiently generate power while optimizing the use and recycling of hydrogen. By employing high-temperature polymer electrolyte membranes and advanced materials, such as graphitic carbon in the bipolar plates, the system achieves superior hydrogen purity and minimizes losses. The unique architecture of the system allows it to operate without the need for conventional mechanical or electrical balance of plant (MBOP/EBOP) components, such as heat exchangers, preheaters, or power converters, thereby simplifying the system, reducing its footprint, and improving overall efficiency. This disclosure addresses the growing need for compact, efficient, and sustainable fuel cell technologies in various energy applications.

### (b) Background

Conventional systems for separating hydrogen from reformed hydrocarbons use steam methane reforming (SMR) reaction, water gas shift (WGS) reaction of converting carbon monoxide (CO) into carbon dioxide (CO₂), etc. and are configured to include an adsorption device, a compressor and the like to obtain pure hydrogen.

Electrochemical hydrogen pumps are receiving attention recently because hydrogen may be continuously separated and compressed using a polymer electrolyte membrane.

Korean Patent Application Publication No. 10-2022-0155914 discloses power generation using a membrane-electrode assembly including a polymer electrolyte membrane as an electrochemical hydrogen pump and using a solid oxide fuel cell (SOFC). However, the membrane-electrode assembly has an operating temperature of about 100° C. to 200° C., while the operating temperature of the solid oxide fuel cell is about 400° C. Hence, in order to use hydrogen generated from the electrochemical hydrogen pump as fuel for the solid oxide fuel cell, a heat exchanger, a preheater, a cooler, a humidifier, etc. are additionally required therebetween. Ultimately, the above conventional technique negates the advantages of the electrochemical hydrogen pump.

### SUMMARY OF THE DISCLOSURE

Therefore, an object of the present disclosure is to provide a fuel cell system having hydrogen separation and hydrogen regeneration capability.

Another object of the present disclosure is to provide a fuel cell system that does not require mechanical balance of plant (MBOP) such as a heat exchanger, a preheater, etc.

Still another object of the present disclosure is to provide a fuel cell system that does not require electrical balance of plant (EBOP) such as a power converter, a system controller, etc.

Yet another object of the present disclosure is to provide a fuel cell system with excellent efficiency due to minimal hydrogen loss.

The objects of the present disclosure are not limited to the foregoing. The objects of the present disclosure will be able to be clearly understood through the following description and to be realized by the means described in the claims and combinations thereof.

An embodiment of the present disclosure provides a fuel cell system, including an electrochemical hydrogen pump (EHP) including a first membrane-electrode assembly including a first electrolyte membrane, a first anode disposed on one side of the first electrolyte membrane, and a first cathode disposed on another side of the first electrolyte membrane, and a first bipolar plate disposed on the first membrane-electrode assembly, and a polymer electrolyte membrane fuel cell (PEMFC) including a second membrane-electrode assembly including a second electrolyte membrane, a second anode disposed on one side of the second electrolyte membrane, and a second cathode disposed on another side of the second electrolyte membrane, and a second bipolar plate disposed on the second membrane-electrode assembly, in which hydrogen discharged from the electrochemical hydrogen pump is fed to the second anode of the polymer electrolyte membrane fuel cell.

The fuel cell system may further include a gas feeder configured to supply a mixed gas to the first anode.

The mixed gas may include a reformed gas produced by steam methane reforming (SMR) reaction, and the reformed gas may include at least hydrogen.

The polymer electrolyte membrane fuel cell may be attached to the electrochemical hydrogen pump by an adhesive portion.

The adhesive portion may have a thickness of 5 mm to 25 mm.

The polymer electrolyte membrane fuel cell may include a high-temperature polymer electrolyte membrane fuel cell.

The first bipolar plate may include a first anode bipolar plate disposed on the first anode and a first cathode bipolar plate disposed on the first cathode, the second bipolar plate may include a second cathode bipolar plate disposed on the second cathode and a second anode bipolar plate disposed on the second anode, and a flow path of the first cathode bipolar plate and a flow path of the second anode bipolar plate may be in communication with each other so that hydrogen discharged from the first cathode is fed to the second anode through the first cathode bipolar plate and the second anode bipolar plate.

A portion of gas discharged from the electrochemical hydrogen pump may be combined with the mixed gas and may be supplied back to the first anode.

Each of the first electrolyte membrane and the second electrolyte membrane may include at least one selected from the group consisting of a polybenzimidazole-based polymer impregnated with phosphoric acid, a quaternary ammonium coordinated polyphenylene-based polymer impregnated with phosphoric acid, and combinations thereof.

Each of the first anode and the second anode may include an anode catalyst and an anode ionomer, the anode catalyst may include at least one selected from the group consisting of platinum, a platinum alloy, and combinations thereof, and the anode ionomer may include at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof.

Each of the first cathode and the second cathode may include a cathode catalyst and a cathode ionomer, the cathode catalyst may include at least one selected from the group consisting of platinum, a platinum alloy, and combinations thereof, and the cathode ionomer may include at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof.

Each of the first bipolar plate and the second bipolar plate may include graphitic carbon.

The density of the graphitic carbon may be 1.0 g/cm³ to 3.0 g/cm³.

Each of the first bipolar plate and the second bipolar plate may include 10 wt % to 30 wt % of a thermosetting resin.

Each of the first bipolar plate and the second bipolar plate may have a resistance of less than 10 mΩ.

The current density of the electrochemical hydrogen pump may be 1 A/cm² to 4 A/cm².

The area of the electrochemical hydrogen pump may be 16 to 60 times the area of the polymer electrolyte membrane fuel cell.

In some embodiments, a fuel cell system comprises an electrochemical hydrogen pump (EHP) including a first membrane-electrode assembly, which comprises a first electrolyte membrane, a first anode disposed on one side of the first electrolyte membrane, a first cathode disposed on the opposite side of the first electrolyte membrane, and a first bipolar plate disposed on the first membrane-electrode assembly. The system further includes a polymer electrolyte membrane fuel cell (PEMFC) comprising a second membrane-electrode assembly, which comprises a second electrolyte membrane, a second anode disposed on one side of the second electrolyte membrane, a second cathode disposed on the opposite side of the second electrolyte membrane, and a second bipolar plate disposed on the second membrane-electrode assembly. The first cathode of the electrochemical hydrogen pump is directly fluidly connected to the second anode of the polymer electrolyte membrane fuel cell.

The fuel cell system may further comprise a gas feeder configured to supply a mixed gas to the first anode. The mixed gas may comprise a reformed gas produced by a steam methane reforming (SMR) reaction, and the reformed gas may comprise at least hydrogen. The polymer electrolyte membrane fuel cell may be attached to the electrochemical hydrogen pump by an adhesive portion, which may have a thickness of about 5 mm to 25 mm. The polymer electrolyte membrane fuel cell may comprise a high-temperature polymer electrolyte membrane fuel cell. The first bipolar plate may comprise a first anode bipolar plate disposed on the first anode and a first cathode bipolar plate disposed on the first cathode, and the second bipolar plate may comprise a second cathode bipolar plate disposed on the second cathode and a second anode bipolar plate disposed on the second anode. A flow path of the first cathode bipolar plate and a flow path of the second anode bipolar plate may be in communication with each other so that hydrogen discharged from the first cathode is fed to the second anode through the first cathode bipolar plate and the second anode bipolar plate. A part of the gas discharged from the electrochemical hydrogen pump may be combined with the mixed gas and supplied back to the first anode.

The first electrolyte membrane may comprise at least one selected from the group consisting of a polybenzimidazole-based polymer impregnated with phosphoric acid, a quaternary ammonium coordinated polyphenylene-based polymer impregnated with phosphoric acid, and combinations thereof. The second electrolyte membrane may comprise at least one selected from the group consisting of a polybenzimidazole-based polymer impregnated with phosphoric acid, a quaternary ammonium coordinated polyphenylene-based polymer impregnated with phosphoric acid, and combinations thereof. Each of the first anode and the second anode may comprise an anode catalyst and an anode ionomer. The anode catalyst may comprise at least one selected from the group consisting of platinum, a platinum alloy, and combinations thereof. The anode ionomer may comprise at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof. Each of the first cathode and the second cathode may comprise a cathode catalyst and a cathode ionomer.

The cathode catalyst may comprise at least one selected from the group consisting of platinum, a platinum alloy, and combinations thereof, and the cathode ionomer may comprise at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof.

Each of the first bipolar plate and the second bipolar plate may comprise graphitic carbon having a density of the graphitic carbon between about 1.0 g/cm³ and about 3.0 g/cm³. The first bipolar plate may comprise about 10 wt % to 30 wt % of a thermosetting resin, and the second bipolar plate may comprise about 10 wt % to 30 wt % of a thermosetting resin. The first bipolar plate may have a resistance of less than about 10 mΩ, and the second bipolar plate may have a resistance of less than about 10 mΩ.

In some embodiments, a fuel cell system comprises an electrochemical hydrogen pump (EHP) including a first membrane-electrode assembly, which comprises a first electrolyte membrane, a first anode disposed on one side of the first electrolyte membrane, a first cathode disposed on the opposite side of the first electrolyte membrane, and a first bipolar plate disposed on the first membrane-electrode assembly. The system further includes a polymer electrolyte membrane fuel cell (PEMFC) comprising a second membrane-electrode assembly, which comprises a second electrolyte membrane, a second anode disposed on one side of the second electrolyte membrane, a second cathode disposed on the opposite side of the second electrolyte membrane, and a second bipolar plate disposed on the second membrane-electrode assembly. The first cathode of the electrochemical hydrogen pump is directly fluidly connected to the second anode of the polymer electrolyte membrane fuel cell. A current density of the electrochemical hydrogen pump is about 1 A/cm² to 4 A/cm², and an area of the electrochemical hydrogen pump is about 16 to 60 times an area of the polymer electrolyte membrane fuel cell. The polymer electrolyte membrane fuel cell is attached to the electrochemical hydrogen pump by a silica adhesive having a thickness of about 5 mm to about 25 mm. The silica adhesive has a thermal expansion coefficient of about 10-5/° F. or less at high temperatures of about 180° C. or more. Each of the first bipolar plate and the second bipolar plate comprises graphitic carbon having a density of the graphitic carbon higher than about 1.8 g/cm³. The first bipolar plate comprises about 10 wt % to 30 wt % of a thermosetting resin, and the second bipolar plate comprises about 10 wt % to 30 wt % of a thermosetting resin. The first bipolar plate has a resistance of less than about 10 mΩ, and the second bipolar plate has a resistance of less than about 10 mΩ.

As discussed, the method and system suitably include use of a controller or processer.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a fuel cell system according to the present disclosure;

FIG. 2 shows an electrochemical hydrogen pump and a polymer electrolyte membrane fuel cell according to the present disclosure;

FIG. 3 is a reference view for explaining the areas of the electrochemical hydrogen pump and the polymer electrolyte membrane fuel cell according to the present disclosure;

FIG. 4 shows results of evaluating current-voltage characteristics when a membrane-electrode assembly according to Example is used as an electrochemical hydrogen pump;

FIG. 5 shows results of measuring voltage at each current when the membrane-electrode assembly according to Example is used as an electrochemical hydrogen pump; and

FIG. 6 shows results of evaluating current-voltage characteristics when the membrane-electrode assembly according to Example is used as a polymer electrolyte membrane fuel cell.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

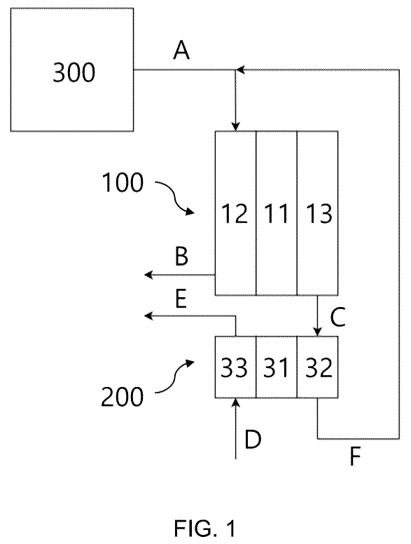

FIG. 1 shows a fuel cell system according to the present disclosure. The fuel cell system may include an electrochemical hydrogen pump 100, a polymer electrolyte membrane fuel cell 200 connected to the electrochemical hydrogen pump 100, and a gas feeder 300 configured to supply a mixed gas A including hydrogen to the electrochemical hydrogen pump 100.

The gas feeder 300 may include a reformer configured to perform steam methane reforming (SMR) reaction, and the mixed gas A may include a reformed gas produced by steam methane reforming reaction.

The reformed gas may include at least hydrogen, and may also include carbon monoxide, carbon dioxide, steam, nitrogen, etc.

A conventional system for producing hydrogen by steam methane reforming reaction additionally requires a water gas shift reactor, a hydrogen separator, a compressor and the like downstream of the reformer. The fuel cell system according to the present disclosure may directly use the reformed gas produced by steam methane reforming reaction without separate post-treatment, thereby minimizing hydrogen loss, being simple, and greatly reducing the overall volume of the system.

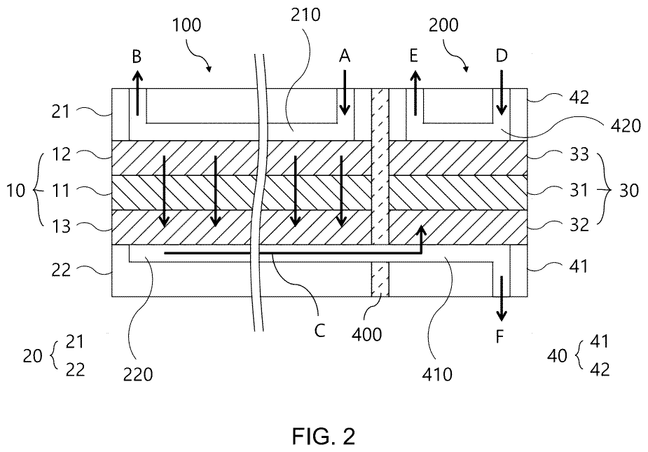

FIG. 2 shows an electrochemical hydrogen pump 100 and a polymer electrolyte membrane fuel cell 200 according to the present disclosure. The electrochemical hydrogen pump 100 and the polymer electrolyte membrane fuel cell 200 may be integrated by being attached by an adhesive portion 400. For example, the electrolyte membrane fuel cell 200 may be attached to the electrochemical hydrogen pump 100 by the adhesive portion 400. Preferably, the electrolyte membrane fuel cell 200 may be attached to a lateral side of the electrochemical hydrogen pump 100 by the adhesive portion 400.

The adhesive portion 400 may include, for example, a silica adhesive. Since the silica adhesive has oxidation resistance, gas resistance, and gas sealing properties, mixing of fuels, products, etc. in places other than the designated flow path between the electrochemical hydrogen pump 100 and the polymer electrolyte membrane fuel cell 200 may be prevented. Also, the silica adhesive has a thermal expansion coefficient of about 10-5/° F. or less at high temperatures of about 180° C. or more, so it is stable because there is no significant deformation in the operating temperature range of the fuel cell system. If the thermal expansion coefficient of the silica adhesive exceeds the above value, thermal changes may occur and cracks or gaps may be formed. Hence, the thermal expansion coefficient thereof has to be managed at the level equal to or less than the above value.

The thickness of the adhesive portion 400 may be 5 mm to 25 mm, preferably 5 mm to 10 mm. If the thickness of the adhesive portion 400 is less than 5 mm, gas sealing between the electrochemical hydrogen pump 100 and the polymer electrolyte membrane fuel cell 200 may deteriorate, and there may be a risk of short circuit. On the other hand, if the thickness of the adhesive portion 400 exceeds 25 mm, structural stability and hydrogen transfer efficiency may deteriorate.

The electrochemical hydrogen pump 100 may include a first membrane-electrode assembly 10 and a first bipolar plate 20 disposed on the first membrane-electrode assembly 10. The first membrane-electrode assembly 10 may include a first electrolyte membrane 11, a first anode 12 disposed on one side of the first electrolyte membrane 11, and a first cathode 13 disposed on another side of the first electrolyte membrane 11. Optionally, the electrochemical hydrogen pump 100 may further include a gas diffusion layer (not shown) between the first membrane-electrode assembly 10 and the first bipolar plate 20. The first bipolar plate 20 may include a first anode bipolar plate 21 disposed on the first anode 12 and a first cathode bipolar plate 22 disposed on the first cathode 13.

The mixed gas A supplied from the gas feeder 300 is fed to the first anode 12 through the first anode bipolar plate 21. Hydrogen in the mixed gas A is oxidized at the first anode 12 and is separated into electrons and protons (H⁺). Carbon monoxide, carbon dioxide, steam, nitrogen, etc. in the mixed gas A do not pass through the first electrolyte membrane 11 and become residual gas B, which is then discharged to the outside through the first anode flow path 210 of the first anode bipolar plate 21. The protons are pumped to the first cathode 13 through the first electrolyte membrane 11, and the electrons move to the first cathode 13 through an external conductive line, etc. The protons and electrons are reduced at the first cathode 13 to produce hydrogen, and the hydrogen C is supplied to the polymer electrolyte membrane fuel cell 200 through the first cathode flow path 220 of the first cathode bipolar plate 22. As more hydrogen is formed at the first cathode 13, the hydrogen is compressed within a limited space, so hydrogen may be supplied to the polymer electrolyte membrane fuel cell 200 even without a separate compressor.

The polymer electrolyte membrane fuel cell 200 may include a second membrane-electrode assembly 30 and a second bipolar plate 40 disposed on the second membrane-electrode assembly 30. Optionally, the polymer electrolyte membrane fuel cell 200 may further include a gas diffusion layer (not shown) between the second membrane-electrode assembly 30 and the second bipolar plate 40. The second membrane-electrode assembly 30 may include a second electrolyte membrane 31, a second anode 32 disposed on one side of the second electrolyte membrane 31, and a second cathode 33 disposed on another side of the second electrolyte membrane 31. The second bipolar plate 40 may include a second anode bipolar plate 41 disposed on the second anode 32 and a second cathode bipolar plate 42 disposed on the second cathode 33.

The second membrane-electrode assembly 30 may be a device configured to generate power using hydrogen supplied from the electrochemical hydrogen pump 100. The first membrane-electrode assembly 10 and the second membrane-electrode assembly 30 according to the present disclosure may be substantially the same. For example, the first membrane-electrode assembly 10 and the second membrane-electrode assembly 30 may have a difference of less than 10% in operating conditions such as temperature, pressure, etc., and preferably have the same conditions. If the difference in operating temperature between membrane-electrode assemblies provided respectively in the electrochemical hydrogen pump and the fuel cell is too large, heat management devices such as a heat exchanger, a cooler, etc. may be additionally required therebetween. Also, a power converter, a system controller, etc. may be required to control the different membrane-electrode assemblies. The present disclosure is characterized in that the first membrane-electrode assembly 10 and the second membrane-electrode assembly 30 are configured to be substantially the same so that they may operate without mechanical or electrical balance of plant. Here, “the same” may mean that not only the compositions, components, etc. are completely the same, but also operating by the same mechanism, using the same electrochemical reaction, etc. are included. Therefore, the first membrane-electrode assembly 10 and the second membrane-electrode assembly 20 should be understood as intended in the present disclosure if the operating methods are the same even when the contents and types of respective components therein are different.

The polymer electrolyte membrane fuel cell 200 may include a high-temperature polymer electrolyte membrane fuel cell. The high-temperature polymer electrolyte membrane fuel cell may indicate a polymer electrolyte membrane fuel cell that operates at a high temperature of about 120° C. to 200° C. Alternatively, the high-temperature polymer electrolyte membrane fuel cell may indicate a polymer electrolyte membrane fuel cell that operates at a relative humidity of about 50% or less. The high-temperature polymer electrolyte membrane fuel cell has the same structure or principle as a conventional low-temperature polymer electrolyte membrane fuel cell, but has advantages such as no water flooding at the anode and no need for a humidification system.

The first cathode flow path 220 of the first cathode bipolar plate 22 and the second anode flow path 410 of the second anode bipolar plate 41 may be in communication with each other. Here, the adhesive portion 400 may not block the first cathode flow path 220 and the second anode flow path 410 but may be located at the periphery thereof. However, the embodiment of the present disclosure is not limited thereto, and for example, the first cathode bipolar plate 22 and the second anode bipolar plate 41 may be integrally formed, so there may be no adhesive portion 400. Hydrogen C discharged from the electrochemical hydrogen pump 100 may be fed to the polymer electrolyte membrane fuel cell 200 through the second anode flow path 410 and may be supplied to the second anode 32.

In addition, oxygen and/or air D may be supplied from the outside through the second cathode flow path 420 of the second cathode plate 42 to feed the oxygen and/or air D to the second cathode 33. Unreacted oxygen and/or unreacted air not fed to the second cathode 33 and the product E at the second cathode 33 may flow along the second cathode flow path 420 and may then be discharged to the outside.

Meanwhile, among the hydrogen C discharged from the electrochemical hydrogen pump 100, unreacted hydrogen not fed to the second anode 32 and the product F at the second anode 32 may be discharged to the outside of the polymer electrolyte membrane fuel cell 200, combined with the mixed gas A as shown in FIG. 1, and supplied back to the electrochemical hydrogen pump 100.

Hereinafter, each configuration will be described in detail.

Each of the first electrolyte membrane 11 and the second electrolyte membrane 31 may include at least one selected from the group consisting of a polybenzimidazole-based polymer impregnated with phosphoric acid, a quaternary ammonium coordinated polyphenylene-based polymer impregnated with phosphoric acid, and combinations thereof. The first electrolyte membrane 11 and the second electrolyte membrane 31 include a polybenzimidazole-based polymer impregnated with phosphoric acid, a quaternary ammonium coordinated polyphenylene-based polymer impregnated with phosphoric acid, etc., rather than perfluorosulfonic acid-based polymers such as Nafion, thus enabling operation at high temperatures of about 120° C. to 200° C., and showing high resistance to carbon monoxide and low-concentration hydrogen fuel compared to low-temperature polymer electrolyte membrane fuel cells that operate at 100° C. or less. Therefore, even when the performance of the electrochemical hydrogen pump deteriorates, there is little impact on the lifespan and performance of the polymer electrolyte membrane fuel cell.

The quaternary ammonium coordinated polyphenylene-based polymer impregnated with phosphoric acid may have an aromatic main chain and a side chain containing a nitrogen-containing functional group and a dihydrogen phosphate anion (H₂PO₄⁻) connected thereto. For example, the quaternary ammonium coordinated polyphenylene-based polymer impregnated with phosphoric acid may include at least one selected from the group consisting of a polymer represented by Chemical Formula 1 to a polymer represented by Chemical Formula 5 below.

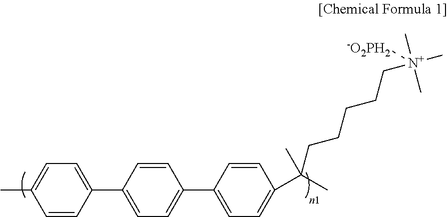

In Chemical Formula 1, n1 may be a number from 100 to 1,000.

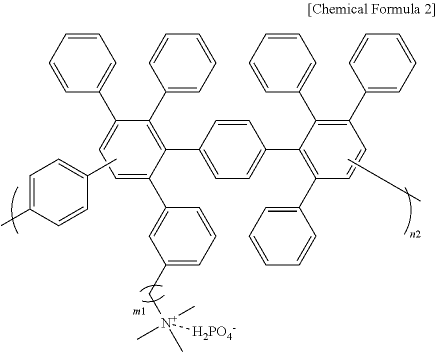

In Chemical Formula 2, n2 may be a number from 100 to 1,000, and m1 may be a number from 3 to 8.

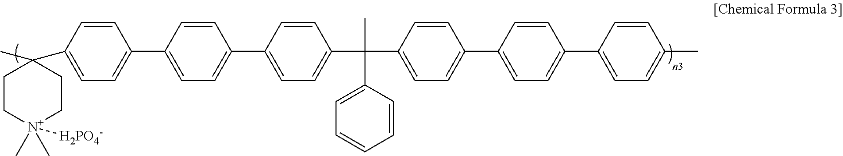

In Chemical Formula 3, n3 may be a number from 100 to 1,000.

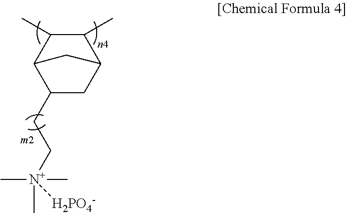

In Chemical Formula 4, n4 may be a number from 100 to 1,000, and m2 may be a number from 1 to 10.

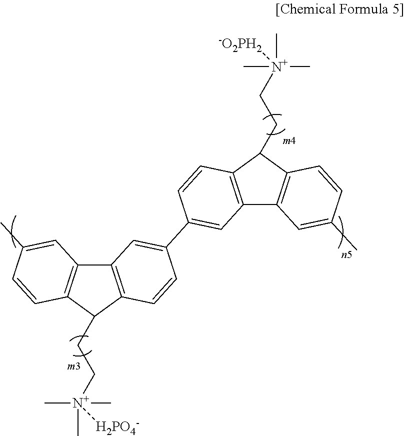

In Chemical Formula 5, n5 may be a number from 100 to 1,000, and each of m3 and m4 may be a number from 1 to 10.

Each of the first anode 12 and the second anode 32 may include an anode catalyst and an anode ionomer.

The anode catalyst may include at least one selected from the group consisting of platinum, a platinum alloy, and combinations thereof. The platinum alloy may include an alloy of platinum and cobalt, an alloy of platinum and nickel, an alloy of platinum and iron, etc. The anode catalyst may be configured such that an active metal such as platinum is loaded on a support. The type of support is not particularly limited and may include carbon, metal oxide, etc.

The anode ionomer may include at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof.

The poly(2,3,5,6-tetrafluorostyrene-4-phosphonic acid) may include a polymer represented by Chemical Formula 6 below.

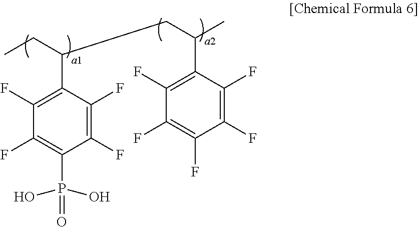

In Chemical Formula 6, a1 may be 0.7a, a2 may be 0.3a, and a may be a number from 100 to 1,000.

Each of the first bipolar plate 20 and the second bipolar plate 40 may include graphitic carbon and a thermosetting resin.

The graphitic carbon is stable at a temperature of about 180° C. or higher and a voltage of about 1.5 V, and has high electrical conductivity, excellent gas sealing properties, and low reactivity with phosphoric acid, so the first bipolar plate 20 and the second bipolar plate 40 containing the same may have excellent physical stability and chemical stability.

The density of the graphitic carbon may be 1.0 g/cm³ to 3.0 g/cm³. If the density of the graphitic carbon is less than 1.0 g/cm³, gas sealing properties may deteriorate and device performance may decrease due to an increase in heat conduction resistance.

Each of the first bipolar plate 20 and the second bipolar plate 40 may include 10 wt % to 30 wt % of the thermosetting resin. If the amount of the thermosetting resin is less than 10 wt %, fine gas may leak and fuel loss may occur, whereas if it exceeds 30 wt %, resistance may increase. The type of thermosetting resin is not particularly limited, but may include, for example, a phenolic resin, an epoxy resin, etc. When the amount of the thermosetting resin falls within the above range, adhesion between graphitic carbons may be maintained over a wide temperature range.

Each of the first bipolar plate 20 and the second bipolar plate 40 may have a resistance of less than 10 mΩ. When the resistance falls within the above range, the first bipolar plate 20 and the second bipolar plate 40 may function as current collectors.

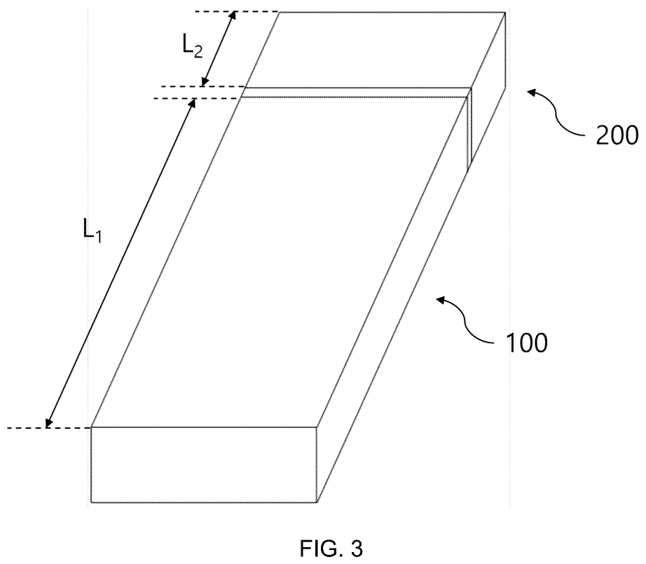

The current density of the electrochemical hydrogen pump 100 may be 1 A/cm² to 4 A/cm². When the current density of the electrochemical hydrogen pump 100 falls within the above range, hydrogen conversion efficiency of 90% or more may be achieved. Also, when the current density of the electrochemical hydrogen pump 100 falls within the above range and the amount of produced hydrogen is about 350 sccm or more, maximum efficiency of the polymer electrolyte membrane fuel cell 200 may be achieved. In order to satisfy the above conditions, the area of the electrochemical hydrogen pump 100 may be adjusted to be 16 to 60 times the area of the polymer electrolyte membrane fuel cell 200. If the area of the electrochemical hydrogen pump 100 is less than 16 times the area of the polymer electrolyte membrane fuel cell 200, the efficiency of the fuel cell 200 may decrease, whereas if it exceeds 60 times, hydrogen recovery efficiency may decrease. For example, as shown in FIG. 3, when the electrochemical hydrogen pump 100 and the polymer electrolyte membrane fuel cell 200 have the same width and thickness, the length L₁ of the electrochemical hydrogen pump 100 may be formed to be 16 to 60 times the length L₂ of the polymer electrolyte membrane fuel cell 200. Meanwhile, the area of the electrochemical hydrogen pump 100 and the area of the polymer electrolyte membrane fuel cell 200 may mean the reaction area. The reaction area may refer to the area of the region where the electrolyte membrane, the anode, and the cathode overlap and electrochemical reaction occurs.

A better understanding of the present disclosure may be obtained through the following examples. However, these examples are merely set forth to illustrate the present disclosure and are not to be construed as limiting the spirit of the present disclosure.

### EXAMPLE

A platinum catalyst and an ionomer were dispersed in n-propanol as a solvent. The platinum catalyst includes 40 wt % of a platinum alloy and 60 wt % of a support. The ionomer is a mixture of poly(2,3,5,6-tetrafluorostyrene-4-phosphonic acid) and Nafion at a mass ratio of 6:4. A slurry was obtained by adding and dispersing the platinum catalyst and the ionomer to and in the solvent such that the ratio of the platinum catalyst relative to the carbon content in the ionomer was about 0.4.

An anode and a cathode were manufactured by applying the slurry onto a substrate.

A membrane-electrode assembly was obtained by interposing an electrolyte membrane between the anode and the cathode followed by bonding. The electrolyte membrane includes a quaternary ammonium coordinated polyphenylene-based polymer impregnated with phosphoric acid represented by Chemical Formula 2.

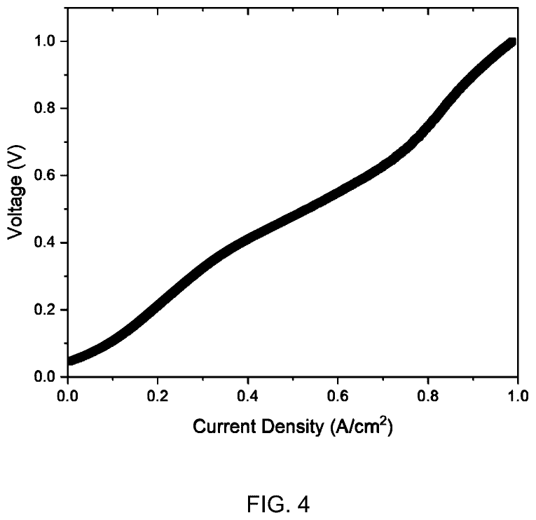

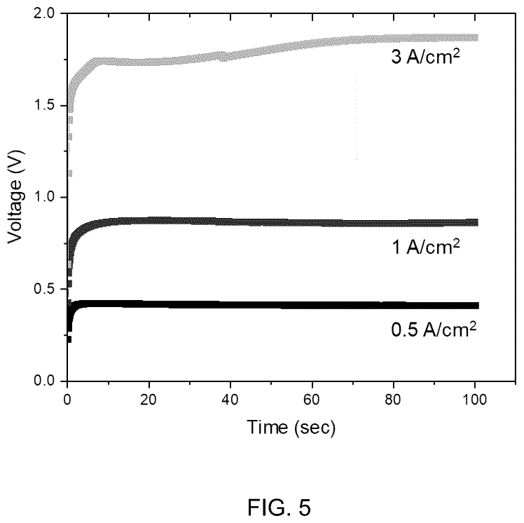

FIG. 4 shows results of evaluating current-voltage characteristics when the membrane-electrode assembly according to Example is used as an electrochemical hydrogen pump. FIG. 5 shows results of measuring the voltage at each current when the membrane-electrode assembly according to Example is used as an electrochemical hydrogen pump. Each evaluation was conducted at about 160° C. Referring to FIG. 4, it can be found that the membrane-electrode assembly is capable of operating as an electrochemical hydrogen pump. Referring to FIG. 5, the membrane-electrode assembly operates at less than 2 V even at a high current of 3 A/cm², confirming applicability of the bipolar plate made of graphitic carbon to the membrane-electrode assembly.

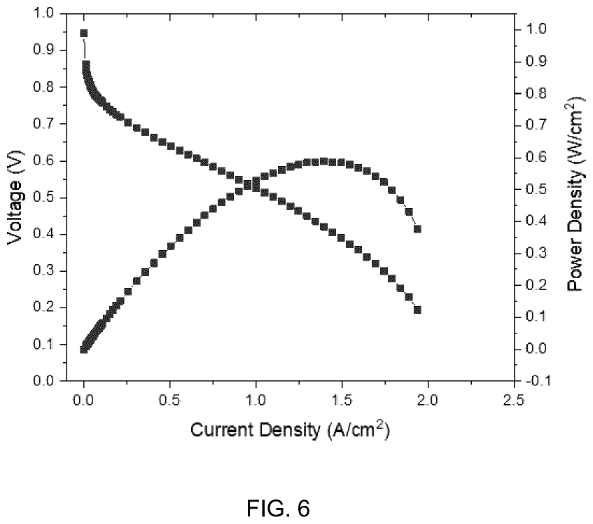

FIG. 6 shows results of evaluating current-voltage characteristics when the membrane-electrode assembly according to Example is used as a polymer electrolyte membrane fuel cell. Measurement was performed by applying a pressure of 1 bar to the membrane-electrode assembly at about 160° C., supplying hydrogen at about 350 sccm to the anode, and supplying air at about 2,500 sccm to the cathode. Referring to FIG. 6, the membrane-electrode assembly appears very stable when used as a polymer electrolyte membrane fuel cell.

Thereby, it can be found that, when two membrane-electrode assemblies that satisfy the conditions proposed in the present disclosure are connected in parallel to function as an electrochemical hydrogen pump and a polymer electrolyte membrane fuel cell, respectively, it is possible to minimize the size of the system and also achieve very efficient power generation.

As is apparent from the above description, according to the present disclosure, a fuel cell system having hydrogen separation and hydrogen regeneration capability can be provided.

According to the present disclosure, a fuel cell system that does not require mechanical balance of plant (MBOP) such as a heat exchanger, a preheater, etc. can be provided.

According to the present disclosure, a fuel cell system that does not require electrical balance of plant (EBOP) such as a power converter, a system controller, etc. can be provided.

According to the present disclosure, a fuel cell system with excellent efficiency due to minimal hydrogen loss can be provided.

The effects of the present disclosure are not limited to the foregoing. It should be understood that the effects of the present disclosure include all effects that can be inferred from the description of the present disclosure.

As the examples of the present disclosure have been described in detail above, the scope of the present disclosure is not limited to the aforementioned examples, and various modifications and improvements made by those skilled in the art using the basic concept of the present disclosure defined in the following claims are also within the scope of the present disclosure.

What is claimed is:

1. A fuel cell system, comprising:
an electrochemical hydrogen pump (EHP) comprising a first membrane-electrode assembly comprising a first electrolyte membrane, a first anode disposed on one side of the first electrolyte membrane, and a first cathode disposed on another side of the first electrolyte membrane, and a first bipolar plate disposed on the first membrane-electrode assembly; and
a polymer electrolyte membrane fuel cell (PEMFC) comprising a second membrane-electrode assembly comprising a second electrolyte membrane, a second anode disposed on one side of the second electrolyte membrane, and a second cathode disposed on another side of the second electrolyte membrane, and a second bipolar plate disposed on the second membrane-electrode assembly,
wherein the first cathode of the electrochemical hydrogen pump is directly fluidly connected to the second anode of the polymer electrolyte membrane fuel cell.

2. The fuel cell system of claim 1, further comprising a gas feeder configured to supply a mixed gas to the first anode.

3. The fuel cell system of claim 2, wherein the mixed gas comprises a reformed gas produced by steam methane reforming (SMR) reaction, and the reformed gas comprises at least hydrogen.

4. The fuel cell system of claim 1, wherein the polymer electrolyte membrane fuel cell is attached to the electrochemical hydrogen pump by an adhesive portion.

5. The fuel cell system of claim 4, wherein the adhesive portion has a thickness of about 5 mm to 25 mm.

6. The fuel cell system of claim 1, wherein the polymer electrolyte membrane fuel cell comprises a high-temperature polymer electrolyte membrane fuel cell.

7. The fuel cell system of claim 1, wherein:
the first bipolar plate comprises a first anode bipolar plate disposed on the first anode and a first cathode bipolar plate disposed on the first cathode,
the second bipolar plate comprises a second cathode bipolar plate disposed on the second cathode and a second anode bipolar plate disposed on the second anode, and
a flow path of the first cathode bipolar plate and a flow path of the second anode bipolar plate are in communication with each other so that hydrogen discharged from the first cathode is fed to the second anode through the first cathode bipolar plate and the second anode bipolar plate.

8. The fuel cell system of claim 2, wherein a part of gas discharged from the electrochemical hydrogen pump is combined with the mixed gas and is supplied back to the first anode.

9. The fuel cell system of claim 1, wherein the first electrolyte membrane comprises at least one selected from the group consisting of a polybenzimidazole-based polymer impregnated with phosphoric acid, a quaternary ammonium coordinated polyphenylene-based polymer impregnated with phosphoric acid, and combinations thereof.

10. The fuel cell system of claim 1, wherein the second electrolyte membrane comprises at least one selected from the group consisting of a polybenzimidazole-based polymer impregnated with phosphoric acid, a quaternary ammonium coordinated polyphenylene-based polymer impregnated with phosphoric acid, and combinations thereof.

11. The fuel cell system of claim 1, wherein:
each of the first anode and the second anode comprises an anode catalyst and an anode ionomer,
the anode catalyst comprises at least one selected from the group consisting of platinum, a platinum alloy, and combinations thereof, and
the anode ionomer comprises at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof.

12. The fuel cell system of claim 1, wherein:
each of the first cathode and the second cathode comprises a cathode catalyst and a cathode ionomer,
the cathode catalyst comprises at least one selected from the group consisting of platinum, a platinum alloy, and combinations thereof, and
the cathode ionomer comprises at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof.

13. The fuel cell system of claim 1, wherein each of the first bipolar plate and the second bipolar plate comprises graphitic carbon having a density of the graphitic carbon between about 1.0 g/cm³ and about 3.0 g/cm³.

14. The fuel cell system of claim 1, wherein the first bipolar plate comprises about 10 wt % to 30 wt % of a thermosetting resin, and the second bipolar plate comprises about 10 wt % to 30 wt % of a thermosetting resin.

15. The fuel cell system of claim 1, wherein the first bipolar plate has a resistance of less than about 10 mΩ and the second bipolar plate has a resistance of less than about 10 mΩ.

16. The fuel cell system of claim 1, wherein a current density of the electrochemical hydrogen pump is about 1 A/cm² to 4 A/cm².

17. The fuel cell system of claim 1, wherein an area of the electrochemical hydrogen pump is about 16 to 60 times an area of the polymer electrolyte membrane fuel cell.

18. A fuel cell system, comprising:
an electrochemical hydrogen pump (EHP) comprising a first membrane-electrode assembly comprising a first electrolyte membrane, a first anode disposed on one side of the first electrolyte membrane, and a first cathode disposed on another side of the first electrolyte membrane, and a first bipolar plate disposed on the first membrane-electrode assembly; and
a polymer electrolyte membrane fuel cell (PEMFC) comprising a second membrane-electrode assembly comprising a second electrolyte membrane, a second anode disposed on one side of the second electrolyte membrane, and a second cathode disposed on another side of the second electrolyte membrane, and a second bipolar plate disposed on the second membrane-electrode assembly,
wherein the first cathode of the electrochemical hydrogen pump is directly fluidly connected to the second anode of the polymer electrolyte membrane fuel cell,
wherein a current density of the electrochemical hydrogen pump is about 1 A/cm² to 4 A/cm²,
wherein an area of the electrochemical hydrogen pump is about 16 to 60 times an area of the polymer electrolyte membrane fuel cell,
wherein the polymer electrolyte membrane fuel cell is attached to the electrochemical hydrogen pump by a silica adhesive having a thickness of about 5 mm to about 25 mm,
wherein the silica adhesive has a thermal expansion coefficient of about 10⁻⁵/° F. or less at high temperatures of about 180° C. or more,
wherein each of the first bipolar plate and the second bipolar plate comprises graphitic carbon having a density of the graphitic carbon higher than about 1.0 g/cm³,
wherein the first bipolar plate comprises about 10 wt % to 30 wt % of a thermosetting resin, and the second bipolar plate comprises about 10 wt % to 30 wt % of a thermosetting resin,
wherein the first bipolar plate has a resistance of less than about 10 mΩ, and
wherein the second bipolar plate has a resistance of less than about 10 mΩ.

19. The fuel cell system of claim 18, wherein:
each of the first anode and the second anode comprises an anode catalyst and an anode ionomer,
the anode catalyst comprises at least one selected from the group consisting of platinum, a platinum alloy, and combinations thereof,
the anode ionomer comprises at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof,
each of the first cathode and the second cathode comprises a cathode catalyst and a cathode ionomer,
the cathode catalyst comprises at least one selected from the group consisting of platinum, a platinum alloy, and combinations thereof, and
the cathode ionomer comprises at least one selected from the group consisting of a perfluorosulfonic acid-based polymer, polytetrafluoroethylene (PTFE), polyvinylidene fluoride (PVDF), polybenzimidazole (PBI), poly(2,3,5,6-tetrafluorostyrene-4-phosphonic acid), and combinations thereof.

20. The fuel cell system of claim 18, wherein the first electrolyte membrane comprises at least one selected from the group consisting of a polybenzimidazole-based polymer impregnated with phosphoric acid, a quaternary ammonium coordinated polyphenylene-based polymer impregnated with phosphoric acid, and combinations thereof, and
wherein the second electrolyte membrane comprises at least one selected from the group consisting of a polybenzimidazole-based polymer impregnated with phosphoric acid, a quaternary ammonium coordinated polyphenylene-based polymer impregnated with phosphoric acid, and combinations thereof.
